(19) United States
(12) Patent Application Publication
(10) Pub. No.: US 2025/0121778 A1
(43) Pub. Date: Apr. 17, 2025

(54) BIKE MOUNT FOR VEHICLE

(71) Applicants: Isaac Jackson, Salt Lake City, UT (US); Theodore R. Espiritu, JR., West Valley, UT (US); Daniel H. Stuart, Layton, UT (US); Colter P. Turley, Ogden, UT (US)

(72) Inventors: Isaac Jackson, Salt Lake City, UT (US); Theodore R. Espiritu, JR., West Valley, UT (US); Daniel H. Stuart, Layton, UT (US); Colter P. Turley, Ogden, UT (US)

(21) Appl. No.: 18/913,802

(22) Filed: Oct. 11, 2024

Related U.S. Application Data
(60) Provisional application No. 63/589,523, filed on Oct. 11, 2023.

(51) Int. Cl. B60R 9/10; B60R 9/06; B62H 3/08

(52) U.S. Cl. CPC B60R 9/10; B60R 9/06; B62H 3/08

(57) ABSTRACT

A bike mount includes a frame including an upright portion and a base portion. The bike mount also includes a first tray pivotally coupled to the upright portion, pivotable in a second rotational direction, and including a first-tray wheel receptacle. The bike mount additionally includes a second tray co-rotatably coupled to the axle and pivotally coupled to the base portion via an axle. The second tray is configured to rotate the axle in a first rotational direction, opposite the second rotational direction, when the second tray is pivoted in the first rotational direction, and the second tray includes a second-tray wheel receptacle. The bike mount also includes a ratcheting mechanism coupled with the axle and configured to enable pivoting of the second tray, via rotation of the axle, in the first rotational direction and to selectively prevent pivoting of the second tray in the second rotational direction.

### CROSS-REFERENCE TO RELATED APPLICATION

This patent application claims the benefit of U.S. Provisional Patent Application No. 63/589,523, filed Oct. 11, 2023, which is incorporated herein by reference in its entirety.

### FIELD

This disclosure relates generally to bike mounts for vehicles, and more particularly to bike mounts for mounting bikes in the bed of a truck.

### BACKGROUND

Bike mounts or bike racks can be used to mount motorized or non-motorized bikes to objects, such as vehicles, stationary walls, or floors. Such bike mounts can include means for temporarily securing one or more bikes to the objects. Mounting bikes to conventional bike mounts can be cumbersome, time-consuming, and labor-intensive.

### SUMMARY

The subject matter of the present application has been developed in response to the present state of the art, and in particular, in response to the shortcomings of bike mounts that have not yet been fully solved by currently available techniques. Accordingly, the subject matter of the present application has been developed to provide bike mounts for vehicles that overcome at least some of the above-discussed shortcomings of prior art techniques.

Disclosed herein is a bike mount. The bike mount includes a frame including an upright portion and a base portion, the base portion extending at an angle with respect to the upright portion. The bike mount also includes a first tray pivotally coupled to the upright portion, pivotable in a second rotational direction, and including a first-tray wheel receptacle. The bike mount further includes an axle rotatably coupled to the base portion. The bike mount additionally includes a second tray co-rotatably coupled to the axle and pivotally coupled to the base portion via the axle. The second tray is configured to rotate the axle in a first rotational direction, opposite the second rotational direction, when the second tray is pivoted in the first rotational direction, and the second tray includes a second-tray wheel receptacle. The bike mount also includes a ratcheting mechanism coupled with the axle and configured to enable pivoting of the second tray, via rotation of the axle, in the first rotational direction and to selectively prevent pivoting of the second tray in the second rotational direction. The preceding subject matter of this paragraph characterizes example 1 of the present disclosure.

The ratcheting mechanism includes a gear co-rotatably coupled to the second tray via the axle. The ratcheting mechanism also includes a pawl moveable between an engagement position, in which the pawl is engaged with the gear to prevent rotation of the gear in the second rotational direction, and a non-engagement position, in which the pawl is disengaged from the gear to enable rotation of the gear in the second rotational direction. The ratcheting mechanism further includes a foot pedal operably coupled to the pawl to move the pawl between the engagement position and the non-engagement position as the foot pedal is actuated. The preceding subject matter of this paragraph characterizes example 2 of the present disclosure, wherein example 2 also includes the subject matter according to example 1, above.

The foot pedal moves the pawl from the engagement position to the non-engagement position as the foot pedal is depressed. The foot pedal moves the pawl from the non-engagement position to the engagement position as the foot pedal is unpressed. The preceding subject matter of this paragraph characterizes example 3 of the present disclosure, wherein example 3 also includes the subject matter according to example 2, above.

The second tray is configured to pivot in the first rotational direction in response to a wheel rolling onto the second tray and towards the upright portion. The first tray is configured to pivot in the second rotational direction, concurrently with the pivoting of the second tray in the first rotational direction, in response to the wheel rolling towards the upright portion onto the second tray and into the first tray. The preceding subject matter of this paragraph characterizes example 4 of the present disclosure, wherein example 4 also includes the subject matter according to any of examples 1-3, above.

A distance, between the first tray and the second tray in a direction away from the upright portion toward the second tray, is adjustable. The preceding subject matter of this paragraph characterizes example 5 of the present disclosure, wherein example 5 also includes the subject matter according to any of examples 1-4, above.

The first tray faces away from the upright portion and towards the second tray. The second tray faces away from the base portion and towards the first tray. The preceding subject matter of this paragraph characterizes example 6 of the present disclosure, wherein example 6 also includes the subject matter according to any of examples 1-5, above.

The first tray includes a curved receptacle defining a radius of curvature. The upright portion includes a pivot point about which the first tray is configured to pivot. The pivot point is located a distance above the base portion that is less than two times the radius of curvature and equal to or greater than the radius of curvature. The preceding subject matter of this paragraph characterizes example 7 of the present disclosure, wherein example 7 also includes the subject matter according to any of examples 1-6, above.

The base portion further includes at least one telescoping bar and a wheel strap attached to the at least one telescoping bar. The at least one telescoping bar is actuatable to adjust a total length of the base portion without adjusting a distance, between the first tray and the second tray in a direction away from the upright portion toward the second tray. The preceding subject matter of this paragraph characterizes example 8 of the present disclosure, wherein example 8 also includes the subject matter according to any of examples 1-7, above.

The at least one telescoping bar is configured to extend a first end of the base portion away from the upright portion in a direction substantially parallel to the base portion. The base portion is coupled to the upright portion at a second end that is opposite to the first end. The preceding subject matter of this paragraph characterizes example 9 of the present disclosure, wherein example 9 also includes the subject matter according to example 8, above.

The angle defined between the upright portion and the base portion is not less than 80 degrees and not greater than 100 degrees. The preceding subject matter of this paragraph characterizes example 10 of the present disclosure, wherein example 10 also includes the subject matter according to any of examples 1-9, above.

The upright portion is pivotally coupled to the base portion such that the angle defined between the upright portion and the base portion is adjustable. The preceding subject matter of this paragraph characterizes example 11 of the present disclosure, wherein example 11 also includes the subject matter according to any of examples 1-10, above.

Each one of the first tray and the second tray is shaped to at least partially nestably receive a portion of a wheel. The preceding subject matter of this paragraph characterizes example 12 of the present disclosure, wherein example 12 also includes the subject matter according to any of examples 1-11, above.

The bike mount further includes a first engagement member co-movably fixed to the first tray. The upright portion includes a second engagement member configured to selectively releasably engage with the first engagement member to selectively releasably retain the first tray in a wheel receiving orientation. The preceding subject matter of this paragraph characterizes example 13 of the present disclosure, wherein example 13 also includes the subject matter according to any of examples 1-12, above.

Further disclosed herein is a system. The system includes a rail configured to be attached to a wall of a vehicle and a bike mount. The bike mount includes a frame including an upright portion and a base portion. The upright portion includes a vehicle-attachment assembly configured to be selectively releasably attached to the rail. The base portion extends at an angle with respect to the upright portion. The bike mount also includes a first tray pivotally coupled to the upright portion, pivotable in a second rotational direction, and includes a first-tray wheel receptacle. The bike mount further includes an axle rotatably coupled to the base portion. The bike mount additionally includes a second tray co-rotatably coupled to the axle and pivotally coupled to the base portion via the axle. The second tray is configured to rotate the axle in a first rotational direction, opposite the second rotational direction, when the second tray is pivoted in the first rotational direction, and the second tray includes a second-tray wheel receptacle. The bike mount also includes a ratcheting mechanism coupled with the axle and configured to enable pivoting of the second tray, via rotation of the axle, in the first rotational direction and to selectively prevent pivoting of the second tray in the second rotational direction. The preceding subject matter of this paragraph characterizes example 14 of the present disclosure.

The rail is an L-track rail includes a plurality of linearly aligned slots. The vehicle-attachment assembly includes at least one protrusion. Each one of the at least one protrusion is configured to be releasably retained within a corresponding one of the linearly aligned slots of the L-track rail. The preceding subject matter of this paragraph characterizes example 15 of the present disclosure, wherein example 15 also includes the subject matter according to example 14, above.

The base portion of the bike mount is configured to contact a floor of the vehicle when the vehicle-attachment assembly of the upright portion is attached to the rail. The upright portion is configured to extend substantially parallel to the wall of the vehicle when the vehicle-attachment assembly is attached to the rail. The preceding subject matter of this paragraph characterizes example 16 of the present disclosure, wherein example 16 also includes the subject matter according to any of examples 14-15, above.

Additionally disclosed herein is a method of mounting a bike to an object. The method of mounting a bike to an object includes moving a front wheel of a bike in a first direction into a second tray of a bike mount fixed to the object. The method of mounting a bike to an object also includes pivoting the second tray in a first rotational direction when the front wheel is in the second tray and the front wheel is moved in the first direction. The method of mounting a bike to an object further includes, after moving the front wheel into the second tray, moving the front wheel of the bike in the first direction into a first tray of the bike mount. The method of mounting a bike to an object additionally includes pivoting the first tray in a second rotational direction, opposite the first rotational direction, when the front wheel is in the first tray, the front wheel is moved in the first direction, the front wheel is in the second tray, and the second tray is pivoting in the first rotational direction. The method of mounting a bike to an object also includes selectively preventing the second tray from pivoting in the second direction to retain the front wheel between the first tray and the second tray. The method of mounting a bike to an object further includes selectively enabling the second tray to pivot in the second direction to remove the front wheel from between the first tray and the second tray. The preceding subject matter of this paragraph characterizes example 17 of the present disclosure.

Selectively preventing the second tray from pivoting includes selectively engaging a pawl with a gear that is co-rotatably coupled with the second tray. Selectively enabling the second tray to pivot in the second direction includes selectively disengaging the pawl from the gear. The preceding subject matter of this paragraph characterizes example 18 of the present disclosure, wherein example 18 also includes the subject matter according to example 17, above.

Selectively engaging the pawl includes actuating a foot pedal, operably coupled with the pawl, from a first position to a second position. Selectively disengaging the pawl includes actuating the foot pedal from the second position to the first position. The preceding subject matter of this paragraph characterizes example 19 of the present disclosure, wherein example 19 also includes the subject matter according to example 18, above.

The method further includes adjusting a distance between the first tray and the second tray, adjusting a distance between the second tray and a strap of the bike mount, and securing a rear wheel of the bike to the bike mount via the strap. The preceding subject matter of this paragraph characterizes example 20 of the present disclosure, wherein example 20 also includes the subject matter according to any of examples 17-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a perspective side view of a bike mounting system shown mounting a bike to a vehicle, according to one or more examples of the present disclosure;

FIG. 1B is a perspective rear view of the bike mounting system of FIG. 1A, according to one or more examples of the present disclosure;

FIG. 1C is a perspective view of a wheel of a bike mounted to the mounting system of FIG. 1A, according to one or more examples of the present disclosure;

FIG. 2A is a perspective view of a bike mount, according to one or more examples of the present disclosure;

FIG. 2B is a top plan view of the bike mount of FIG. 2A, according to one or more examples of the present disclosure;

FIG. 2C is a rear view of the bike mount of FIG. 2A, according to one or more examples of the present disclosure;

FIG. 2D is a side elevation view of the bike mount of FIG. 2A, according to one or more examples of the present disclosure;

FIG. 2E is a perspective view of a ratcheting system of the bike mount of FIG. 2A from a first side of the bike mount, with some parts of the ratcheting system shown transparently to promote clearer viewing of other parts of the ratcheting system, according to one or more examples of the present disclosure;

FIG. 2F is a perspective view of the ratcheting system of the bike mount of FIG. 2A from a second side of the bike mount, with some parts of the ratcheting system shown transparently to promote clearer viewing of other parts of the ratcheting system, according to one or more examples of the present disclosure;

FIG. 2G is a front view of the bike mount of FIG. 2A, according to one or more examples of the present disclosure;

FIG. 3A is a top plan view of a bike mounting system mounted to a bed of a vehicle, according to one or more examples of the present disclosure;

FIG. 3B is a rear view of the bike mounting system of FIG. 3A, according to one or more examples of the present disclosure;

FIG. 4A is a perspective view of a bike mounting system, shown with a bike mount of the system in a bike receiving state, according to one or more examples of the present disclosure;

FIG. 4B is a perspective view of a bike mounting system, shown with a bike mount of the system in an intermediate mounting state, according to one or more examples of the present disclosure;

FIG. 4C is a perspective view of a bike mounting system, shown with a bike mount of the system in a bike mounted state, according to one or more examples of the present disclosure;

FIG. 5 is a schematic flow chart of a method of mounting a bike to a bike mount, according to one or more examples of the present disclosure;

FIG. 6 is a perspective view of a tray assembly of a bike mount, according to one or more examples of the present disclosure;

FIG. 7 is a perspective view of the tray assembly of FIG. 6, coupled to a upright portion of a bike mount, according to one or more examples of the present disclosure; and

FIG. 8 is a side elevation view of a bike mount in a retracted state, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

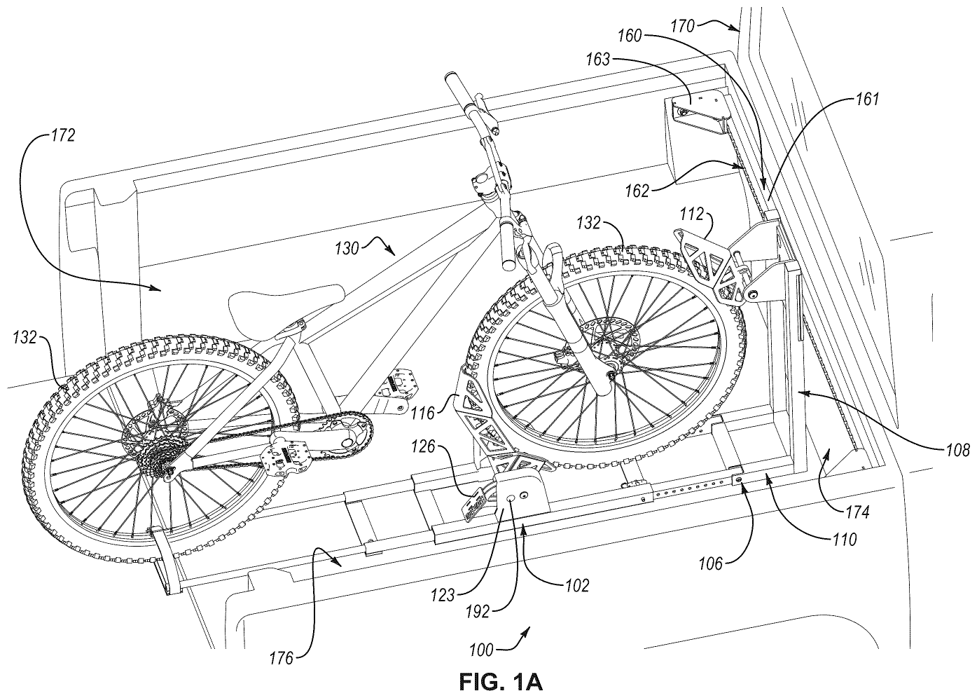

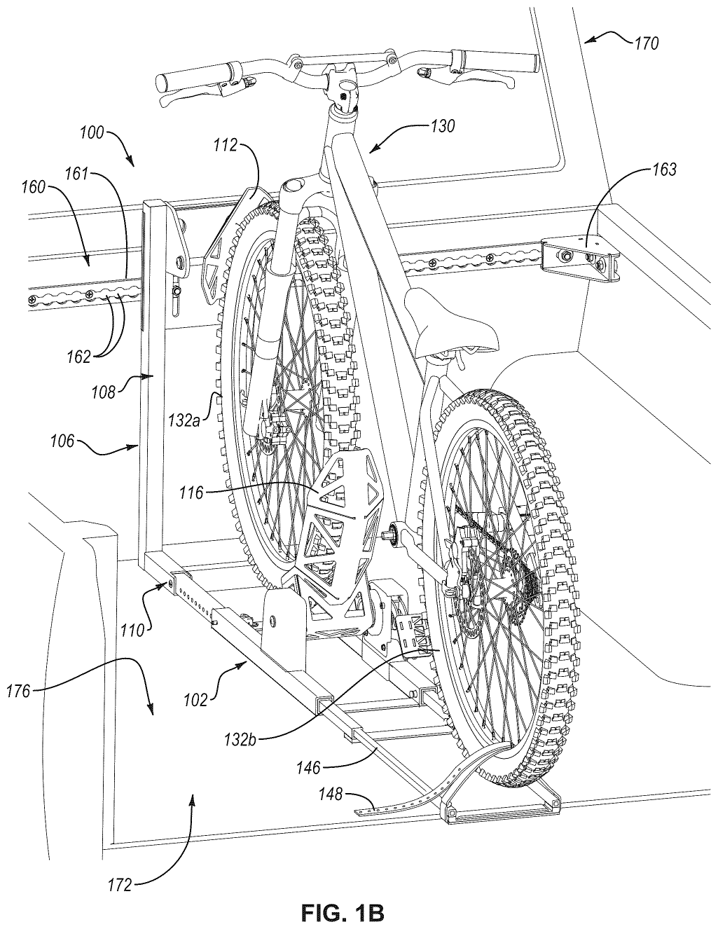

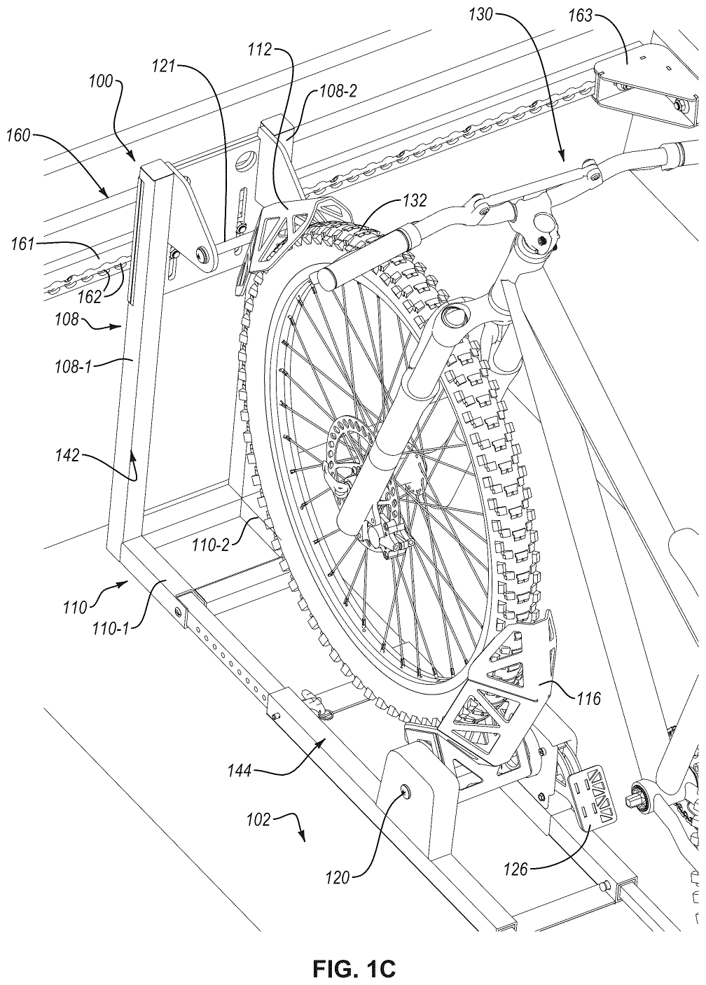

Referring to FIGS. 1A-1C, examples of the present disclosure include a bike mounting system 100 for securing and/or mounting a bike 130 to at least one of a vehicle 170 (e.g., a truck bed floor 176, a truck bed wall 174, a trailer bed, and/or the like), a surface of a moving or stationary non-vehicular object (e.g., floor of a garage, retail store, etc.), or any combination thereof. In some examples, the bike 130 is received and retained by the bike mounting system 100, such as via a bike mount 102 of the bike mounting system 100, without direct engagement between the user's hands and the bike mounting system 100. Accordingly, examples of the present disclosure help to reduce the complexity, time, and labor needed to mount a bike 130 to a bike mount 102 by simply manually pushing the bike 130 into engagement with the bike mount 102 without removing hands from the bike 130.

As used herein, the term “bike” refers to any wheeled equipment (e.g., equipment with at least one wheel) designed to transport people and/or cargo. Accordingly, a “bike” can be any vehicle having a wheel whether motorized or non-motorized or whether designed for a single rider/passenger or multiple riders/passengers. In some examples, a “bike” can include a bicycle, a motorcycle, a moped, a scooter, a unicycle, an all-terrain vehicle, an off-road motorcycle, or any combination thereof. In the illustrated examples, such as shown in FIGS. 1A-C, the bike 130 is a two-wheeled bicycle or a non-motorized bike. As additionally used herein, a “vehicle” includes any vehicle capable of having a bike mounted thereon via the bike mount 102 or the bike mounting system 100. A “vehicle” includes, for example, automobiles, trucks, cars, boats, ships, trains, airplanes, trailers, vans, or any combination thereof. In the illustrated examples, as shown in FIGS. 1A-C, the vehicle 170 is a truck 170 having a truck bed 172 to which the bike mounting system 100 is attached.

Referring to FIGS. 1A-C, in some examples, the bike mounting system 100 includes a mount attachment system 160 configured to attach the bike mount 102 to an object, such as the vehicle 170. Hereafter, the bike mounting system 100 will be described in associated with the vehicle 170, but can be associated with any object (i.e., the vehicle 170 can be interchanged with any object to which mounting of a bike is desired). Accordingly, the mount attachment system 160 acts as an interface between the bike mount 102 and the vehicle 170. The mount attachment system 160 is fixed to the vehicle 170. In some examples, the mount attachment system 160 is adjustably fixed to the vehicle 170 so that the position of the bike mount 102 relative to the vehicle 170 is adjustable to accommodate differently sized vehicles or bikes. The mount attachment system 160 can be attached to the vehicle 170 in any of various ways, which can be dependent on the type, configuration, and/or accessories of the vehicle 170. In the illustrated examples, the vehicle 170 is a truck that has accessory mounting rails incorporated into the bed of the truck. Therefore, the mount attachment system 160 can utilize the accessory mounting rails to facilitate attachment of the mount attachment system 160 to the vehicle 170.

In the illustrated examples, the mount attachment system 160 includes an attachment rail 161 having a plurality of attachment slots 162. The attachment rail 161 further includes brackets 163 (e.g., as shown in FIG. 1C) on the opposite ends of the attachment rail 161. The brackets 163 are configured to engage the accessory mounting rails of the vehicle 170, which can be mounted to the sidewalls of the bed 172 of the truck 170 or the floor 176 of the truck 170. In some examples, the mount attachment system 160 includes an L-track rail. Alternatively, the mount attachment system 160 can include a panel with openings and/or slots rather than a rail.

The bike mount 102 of the bike mounting system 100 can be adjustably attached to the attachment rail 161 of the mount attachment system 160 at any of various locations along the attachment rail 161 to accommodate the widths of differently sized bikes or to accommodate multiple bikes in a side-by-side manner. The bike 130 is loaded on and secured to the vehicle 170 via the bike mount 102. Because the bike mount 102 is fixed to the mount attachment system 160, securing the bike 130 to the bike mount 102 in turn secures the bike 130 to the vehicle 170.

The bike mount 102 includes a frame 106. In some examples, the frame 106 is made of a substantially rigid material, or a material with a relatively high tensile strength and stiffness. For example, the frame 106 can be made of a metallic material, such as aluminum, steel, or combination thereof.

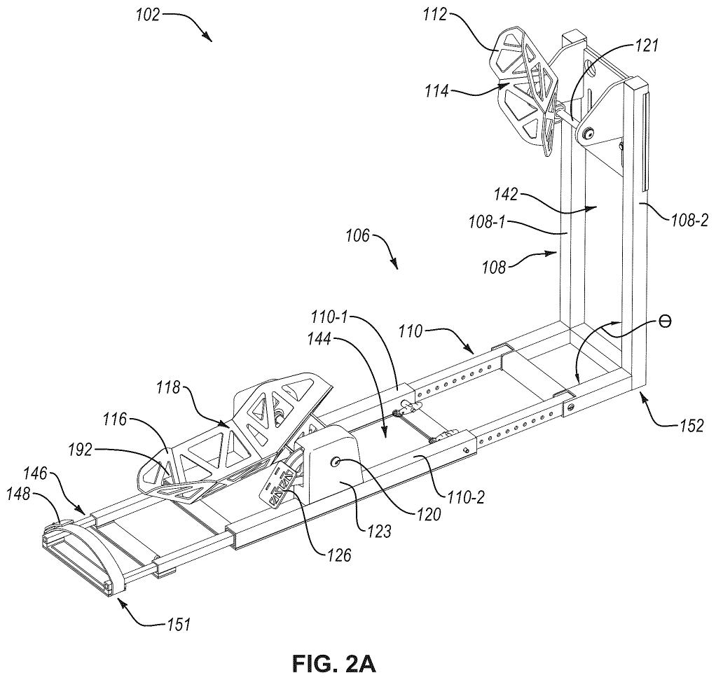

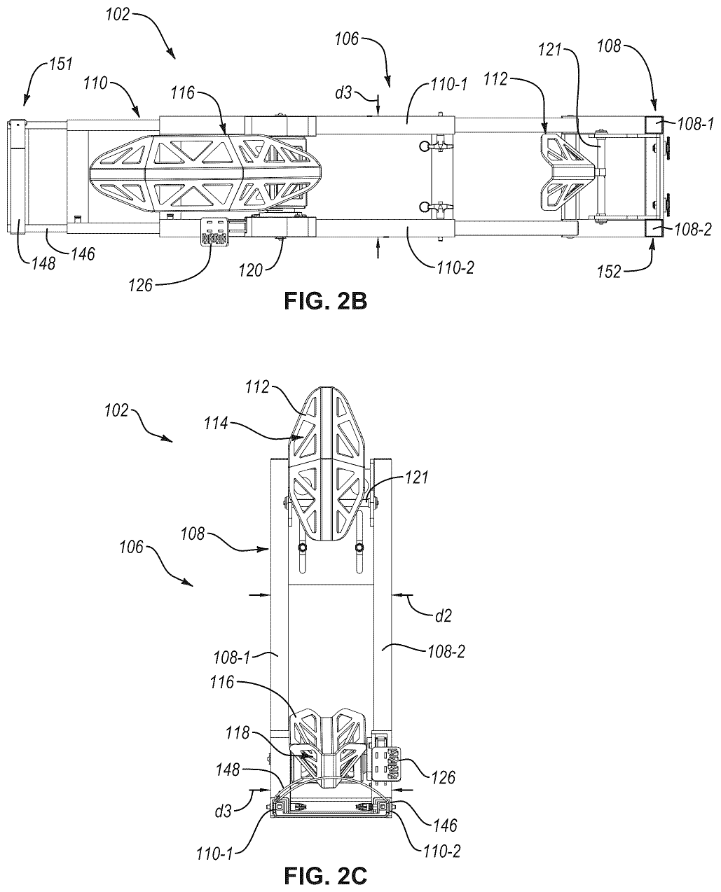

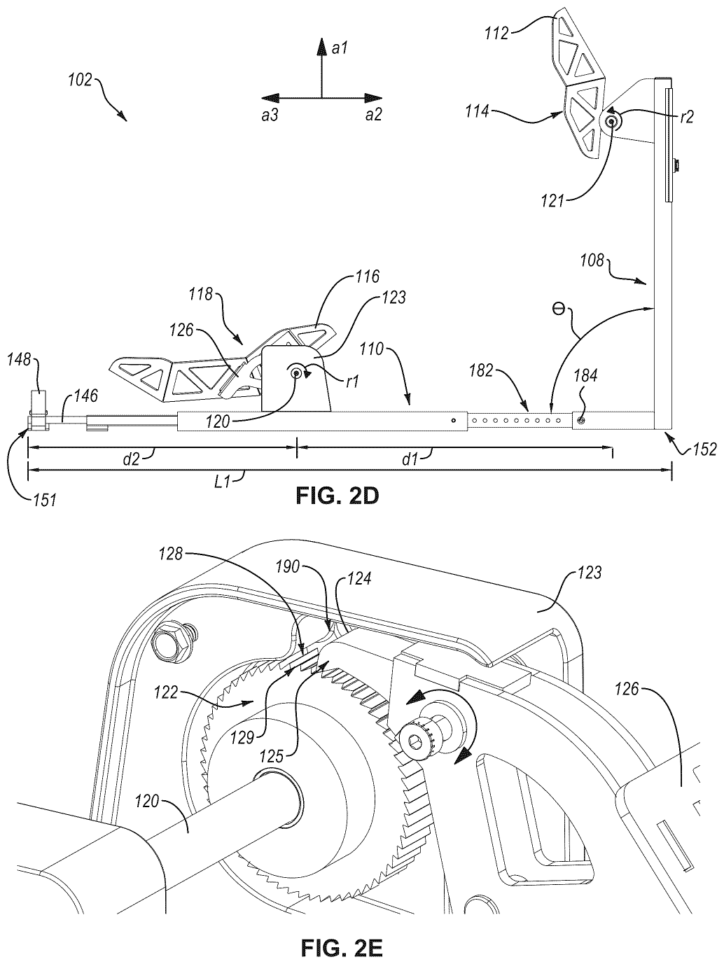

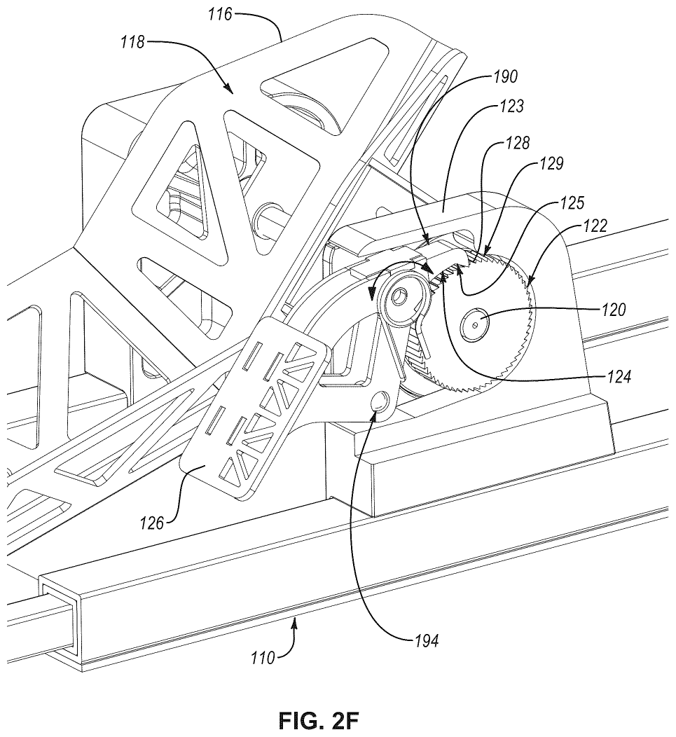

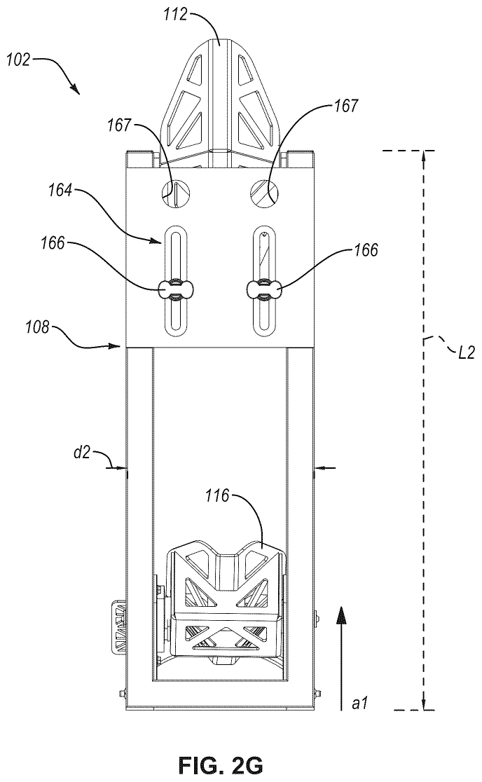

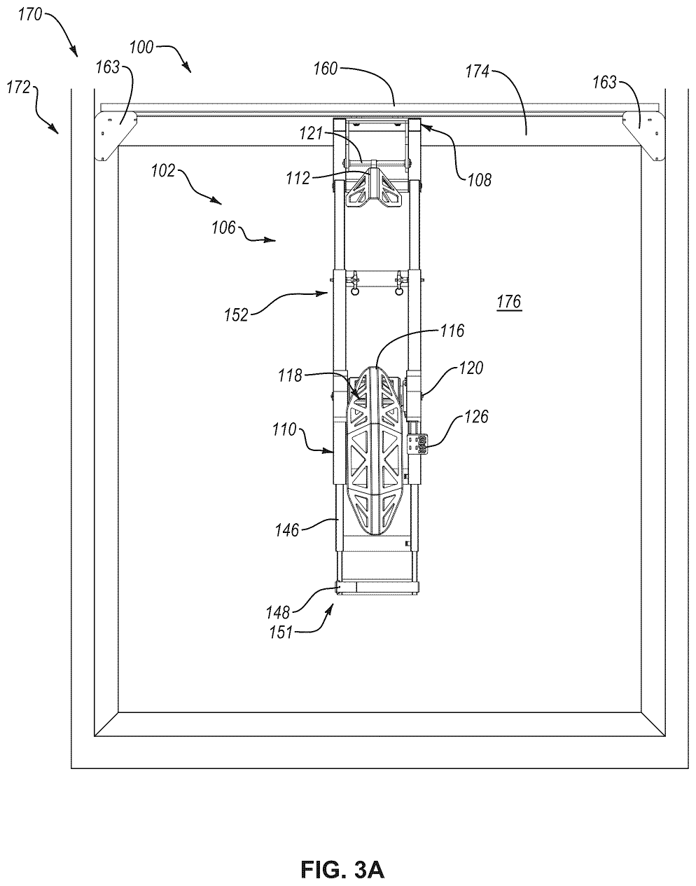

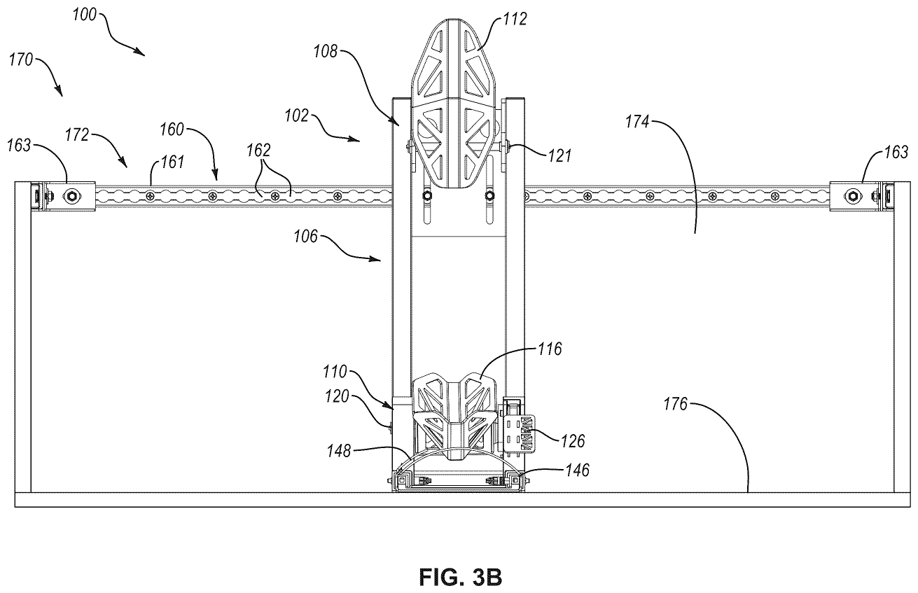

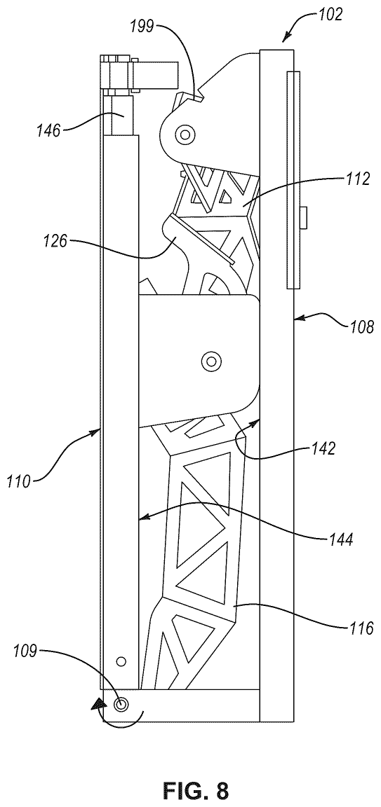

The frame 106 includes an upright portion 108 and a base portion 110. As shown in FIG. 2D, the upright portion 108 and the base portion 110 define an angle θ with respect to each other. In some examples, the angle θ is not less than 80 degrees and not greater than 100 degrees. In certain examples, the angle θ is approximately 90 degrees. According to various examples, the upright portion 108 is coupled to the base portion 110 so that the angle θ is adjustable. For example, referring to FIG. 8, the base portion 110 can be rotatably attached to the upright portion 108 at a pivot 109 such that the base portion 110 can be rotated about the pivot 109 from an extended position (see, e.g., FIGS. 1A-1C), where the angle θ is approximately 90 degrees, to a retracted or storage position (see, e.g., FIG. 8), where the angle θ is approximately zero degrees. In other examples, the angle θ can be similarly adjustable into any of various oblique angles to accommodate oblique angles between a floor 176 and a wall 174 of the vehicle 170, and/or to accommodate bike wheels of significantly different sizes.

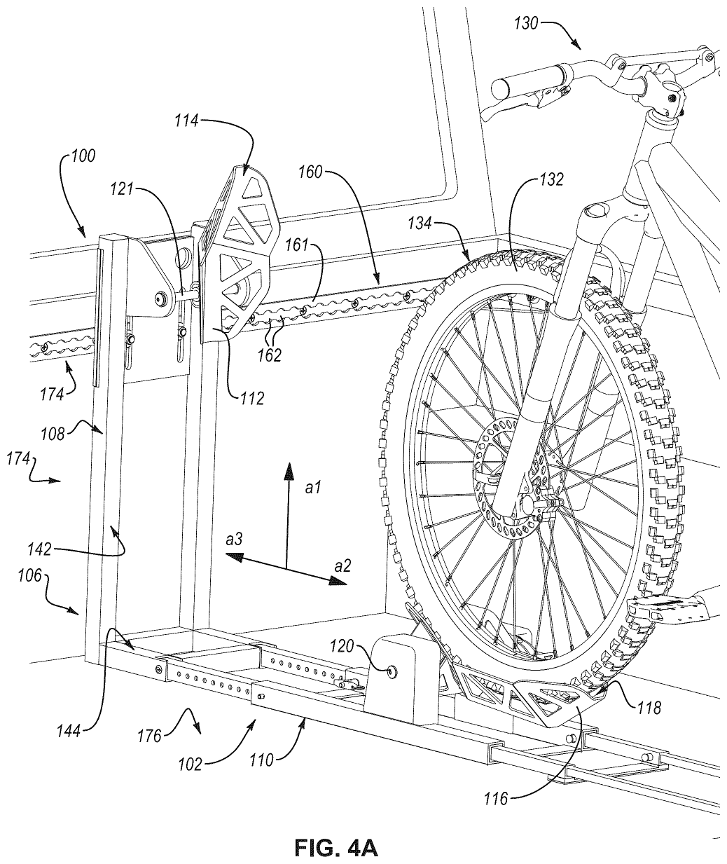

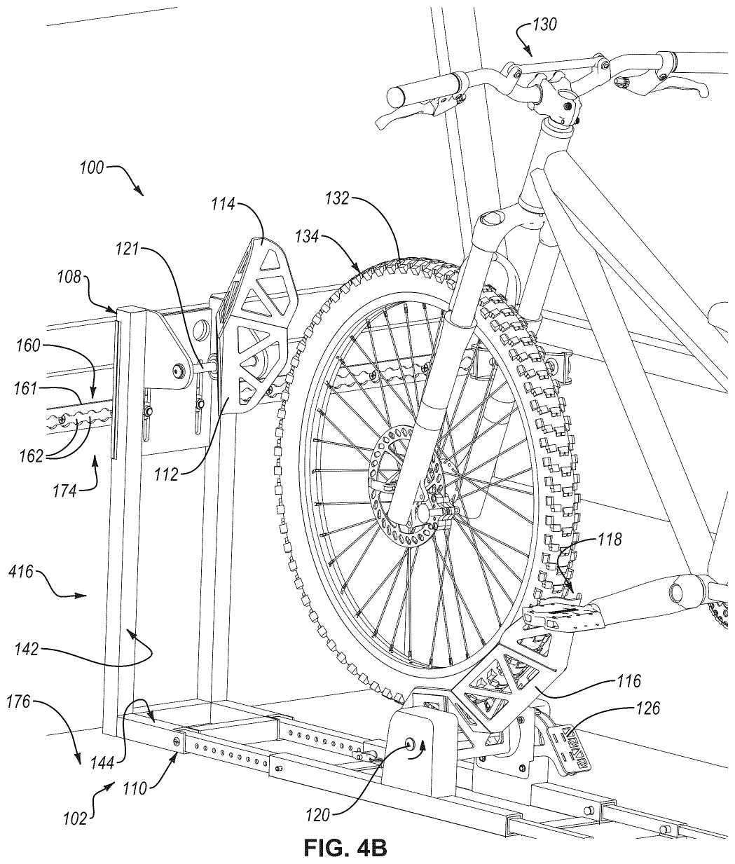

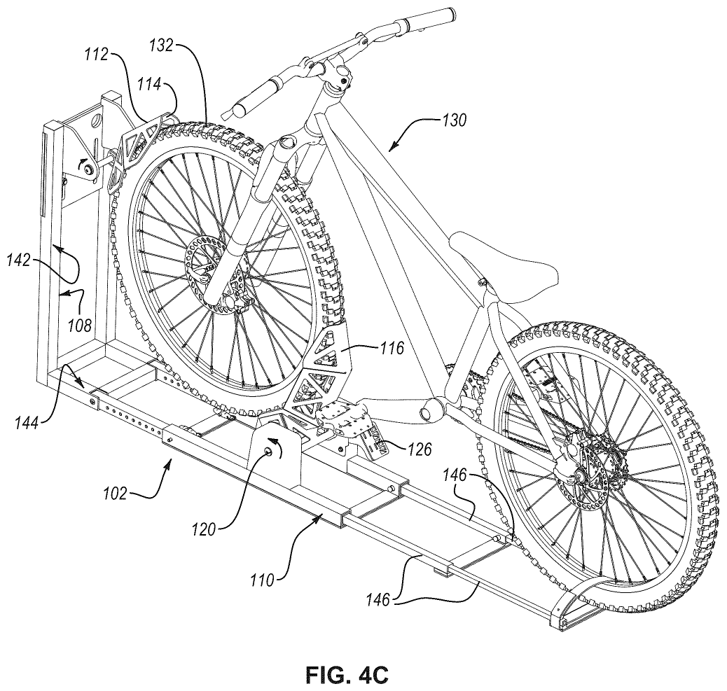

Referring to FIGS. 1C-2C, the upright portion 108 includes at least two legs 108-1 and 108-2, which are spaced apart from each other and extend substantially parallel to each other along a length of the upright portion 108. In some examples, the upright portion 108 extends lengthwise in a direction a1 (see, e.g., FIG. 2D). In some examples, as shown in FIG. 4A, the direction a1 is substantially parallel to a wall 174 of a truck bed 172, or substantially perpendicular to a floor 176 of the truck bed 172, in which the bike mount 102 is located. In some examples, as shown in FIGS. 2B and 2C, a distance d2 between two legs 108-1 and 108-2 of the upright portion 108 is greater than a width of a wheel 132 to be received by the bike mount 102. The distance d2 can be adjustable to accommodate different wheel widths in some examples. Although not shown, in some examples, the upright portion 108 has a length L2 that is adjustable (see, e.g., FIG. 2G). For example, the upright portion 108 may include a telescoping portion that expands to increase a length L2 of the upright portion 108 to accommodate a wheel with a larger diameter, or retracts to decrease the length L2 for smaller wheels.

Referring to FIG. 2F, the upright portion 108 includes a vehicle-attachment assembly 164 configured to facilitate removable, but secure, attachment of the upright portion 108, and thus the bike mount 102, to the mount attachment system 160. In some examples, the vehicle-attachment assembly 164 includes an attachment plate with one or more openings. In some examples, the vehicle-attachment assembly 164 includes protrusions 166 each engaged with (e.g., passing through) a corresponding one of the openings or slots and configured to be removably inserted into and secured by corresponding ones of the slots 162 of the mount attachment system 160. For example, the protrusions 166 include portions shaped to mate with the slots 162 and the protrusions 166 further include tightening features that can be tightened to retain the protrusions 166 in the slots 162. In some examples, one or more openings of the attachment plate of the vehicle-attachment assembly 164 can be a bike lock opening 167 configured to receive a portion of a bike lock (e.g., chain, cable, U-lock, etc.) to accommodate locking the bike 130 to the bike mount 102.

In some examples, the base portion 110 extends lengthwise in a direction a2 that is approximately perpendicular to the direction a1 of the upright portion 108. As shown in FIG. 4A, the direction a2 is substantially parallel to a floor 176 of a truck bed 172, or substantially perpendicular to the wall 174 of the truck bed 172, in which the bike mount 102 is located. In some examples, as shown in FIGS. 2B and 2C, a distance d3 between two legs 110-1 and 110-2 of the base portion 110 is greater than a width of the wheel 132. The distance d3 can be adjustable to accommodate different widths, similar to the distance d2 of the upright portion 108. According to certain examples, the distance d2 is equal to the distance d3. Referring to FIGS. 2A and 2D, the base portion 110 is attached to the upright portion 108 at an end 152 of the base portion 110. In some examples, the end 152 of the base portion 110 is attached to an end of the upright portion 108, such that the frame 106 forms an L-shape.

Referring to FIG. 2D, in some examples, a length L1 of the base portion 110 of the frame 106 is adjustable. For example, the length L1 can be adjustable to increase or decrease a distance d1, in the direction a2, between a first tray 112 (e.g., a pivot point of the first tray 112) and a second tray 116 (e.g., a pivot point of the second tray 116) of the bike mount 102. In one example, as shown in FIG. 2D, the legs 110-1 and 110-2 of the base portion 110 can include segments, coupled together in a telescoping arrangement where each segment includes one or more apertures 182, and a pin 184 that passes through aligned apertures 182 of the segments to secure the segments together at a particular length L1 of the base portion 110. Adjustment of the distance d1 helps to accommodate tires of various sizes and dimensions. Additionally, adjustment of the distance d1 changes the total length L1 of the base portion 110.

In some examples, the base portion 110 includes a rear telescoping bar 146. The rear telescoping bar 146 is configured to facilitate adjustment of the total length L1 of the base portion 110 without changing the distance d1 between the first axle 120 and the second axle 121. The telescoping bar 146 defines a first end 151 of the base portion 110, which can be opposite the end 152 of the base portion 110 and is movable in the direction a2 or the direction a3 substantially parallel to the base portion 110 and respectively away from or toward the upright portion 108. As such, the bike mount 102 can be adjusted to accommodate various sizes and shapes of the bike 130 being mounted. For example, the telescoping bar 146 adjusts the length L1 of the base portion 110 according to the distance between the front wheel 132a and a rear portion of the bike 130 (e.g., the rear wheel 132b). To help further secure the bike 130 (e.g., to secure the bike 130 at the rear of the bike 130), the strap 148 can be tightened down on the rear portion of the bike 130 to secure the rear portion of the bike 130 to the first end 151 (see, e.g., FIGS. 1B and 4C).

The bike mount 102 also includes the first tray 112 (e.g., first chock) and the second tray 116 (e.g., second chock), mentioned above. Each one of the first tray 112 and the second tray 116 is pivotally coupled to a corresponding one of the upright portion 108 and the base portion 110 of the frame 106. More specifically, the first tray 112 is pivotally coupled to the upright portion 108, and the second tray 116 is pivotally coupled to the base portion 110. Referring to FIGS. 1C and 2A-2D, the first tray 112 can be pivotable about a first axle 121, which defines an axis of rotation of the first tray 112 and extends in a direction substantially perpendicular to each of the directions a1 and a2. In some examples, the first axle 121 extends in a direction that is coming out of the page in FIG. 2D. As shown in FIG. 2D, in some examples, the first tray 112 is coupled to the first axle 121 at an intermediate location on a lower half of the first tray 112 and on a convex side of the first tray 112. In such examples, the first tray 112 includes a wheel receptacle 114, and the wheel receptacle 114 of the first tray 112 faces away from the upright portion 108. In some examples, the wheel receptacle 114 is a concave side of the first tray 112. In some examples, the first tray 112 freely rotates, and the bike mount 102 does not include any pawls that impede or resist the rotation of the first tray 112. For example, as can be seen in the difference between the position of the first tray 112 in FIG. 4B and the position of the first tray 112 in FIG. 1C, the tray 112 rotates in a rotational direction r2 in response to contact with the wheel 132 as the wheel 132 moves in a direction a3 towards the upright portion 108.

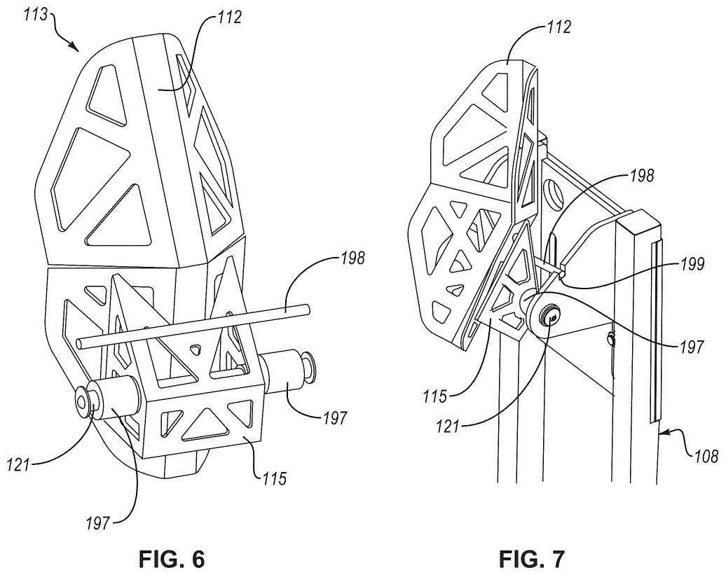

Referring to FIGS. 6 and 7, in some examples, although the first tray 112 is freely rotatable, some resistance to rotation in the rotational direction r2 from an open position is provided to help keep the first tray 112 in the open position when not securing a wheel or tire. This helps ensure that the first tray 112 is open and ready to receive the front wheel of a bike as the bike is mounted to the bike mount 102. However, the resistance to rotation is only enough to keep the first tray 112 in the open position when not in use, but not enough to prevent rotation in the rotational direction r2 when a wheel is pushed into engagement with the first tray 112. In the illustrated example, the first tray 112 is part of a tray assembly 113 that also includes a mounting bracket 115 fixed to the convex side of the first tray 112. The mounting bracket 115 retains the first axle 121. In some examples, the strength of the first axle 121 is increased by a pair of spacers 197 on the first axle 121 on opposite sides of the mounting bracket 115. The mounting bracket 115 additionally includes a pin 198 that is fixed relative to the first tray 112 so that the pin 198 does not move relative to the first tray 112. When the first tray 112 is in the open position (see, e.g., FIG. 7), the pin 198 engages a notch 199 formed in a bracket of the upright portion 108 of the frame 106. Based on its size, shape, and location, the notch 199 provides some resistance against the pin 198 becoming disengaged from the notch 199.

In some examples, the second tray 116 is coupled to and pivotable about a second axle 120, which is indirectly coupled to the base portion 110. As shown in FIG. 2D, in some examples, the second axle 120 is raised from the base portion 110 via a housing 123. In some examples, the second axle 120 and the second tray 116 are fixed together such that they rotate together. The second axle 120 defines an axis of rotation for the second tray 116 to rotate relative to the frame 106. The axis of rotation of the second axle 120 is perpendicular to a1, a2, and a3 and comes out of the page in FIG. 2D. In some examples, the axles 120 and 121 are substantially parallel.

According to certain examples, each one of the first tray 112 and the second tray 116 define wheel receiving surfaces that are curved (e.g., concave) in a plane parallel to the directions a1 and a2 to accommodate the curvature of a wheel along a portion of the circumference of the wheel (e.g., tire). In some examples, the wheel receiving surfaces of the first tray 112 and the second tray 116 are also curved in a perpendicular plane, or a plane parallel to the axes of rotation of the trays . . . to accommodate the curvature of the wheel along a width of the wheel (e.g., tire). Accordingly, each one of the first tray 112 and the second tray 116 have an elongated cupping shape to accommodate the curvatures of the outer surfaces of the wheel 132. Although the first tray 112 and the second tray 116 have been described as being curved in multiple planes, in some examples, the first tray 112 and the second tray 116 are curved in only one plane or not curved in any plane.

In some examples, one or more of the first tray 112 and the second tray 116 include a number of openings 192 or cutouts, such as shown in FIG. 2A. In some examples, the openings 192 extend through a thickness of the first tray 112 or the second tray 116. As such, the openings 192 can help to reduce the weight of the first tray 112 and/or the second tray 116 without compromising structural strength.

Together, the first tray 112 and the second tray 116 are configured to secure a wheel 132 of a bike 130 between the first tray 112 and the second tray 116. As shown in FIGS. 1A-1C and 4A-4C, the first tray 112 and the second tray 116 create a fit with the wheel 132 to secure the bike 130 in the bike mount 102. As shown in FIGS. 4A-4C, as a user guides a wheel 132 of a bike 130 onto the second tray 116 and over the second axle 120, the force of the wheel 132 against the second tray 116 causes the second tray 116 (and the second axle 120 in some examples) to rotate in a direction r1 (see, e.g., FIG. 2D). As such, as shown in FIGS. 4B and 1A-1C, the wheel receptacle 118 of the second tray 116 faces the upright portion 108 and the first tray 112. In some examples, the wheel receptacle 118 is defined by a concave side of the second tray 116.

The first tray 112 and the second tray 116 are mounted to sides 142 and 144 of the upright portion 108 and the base portion 110, respectively, that face each other (see, e.g., FIG. 2A). As such, as the wheel 132 initially engages with the second tray 116 and is pushed further along the frame 106 in the direction a3 toward the upright portion 108, the wheel 132 engages the first tray 112 while remaining engaged with the second tray 116. Referring to FIGS. 1C and 4C, when the length L1 of the base portion 110 is adjusted according to a diameter of the wheel 132, the first tray 112 and the second tray 116 concurrently form a friction fit with the wheel 132, thus securing the wheel 132 within and between the first tray 112 and the second tray 116. Due to the self-pivoting of the first tray 112 and the second tray 116, the user is able to guide the bike 130 over the frame 106 without engaging their hands with the first tray 112 or the second tray 116. The entire process of mounting the bike 130 to the bike mount 102 can be accomplished without the user engaging their hands with the bike mount 102. This helps to improve ease of mounting by allowing the user to keep their hands on the bike 130 being mounted.

As shown in FIGS. 1C and 4C, in some examples, the first tray 112 is located to contact a portion of the wheel 132 on an upper forward half of the wheel, and the second tray 116 is located to contact a portion of the wheel 132 on a rearward lower half of the wheel 132. Accordingly, the first tray 112 prevents forward and upward motion of the wheel 132 relative to the frame 106, and the second tray 116 prevents rearward and downward motion of the wheel 132 relative to the frame 106. In some examples, at least a portion of the wheel 132 contacts a truck bed floor 176 when the wheel 132 is mounted. As shown in FIGS. 1C and 4C, in some examples, the first tray 112 includes a curved receptacle 114 defining a radius of curvature. The first axle 121 can be located a distance above the base portion 110 that is less than two times the radius of curvature and equal to or greater than the radius of curvature.

Referring to FIGS. 2E and 2F, the bike mount 102 further includes a ratcheting assembly 190 coupled to the base portion 110 of the frame 106. The ratcheting assembly 190 includes a gear 122 (e.g., toothed wheel) that co-rotates with the second tray 116. For example, the gear 122 rotates in the first rotational direction r1 shown in FIG. 2E in response to rotation of the second tray 116 in the first rotational direction r1. In some examples, the ratcheting system 190 is within the housing 123, which is coupled to the base portion 110. FIG. 2E is a view of the ratcheting system 190 with at least part of the housing 123 removed and from the perspective of the second tray 116. In certain examples, when the second axle 121 co-rotates with the second tray 116, the gear 122 is coupled to the second axle 121 and configured to co-rotate with the second axle 121. The second axle 121 can be a central shaft of the gear 122. In some examples, the second axle 121 is concentric with the gear 122 and defines an axis of rotation of the gear 122 as well as the second tray 116. The second axle 121, in some examples, is substantially perpendicular to the length L1 of the base portion and to the directions a2 and a3. In some examples, the axle 121 is also perpendicular to a length L2 of the upright portion 108.

As shown in FIG. 2E, the ratcheting system 190 further includes a pawl 124 co-movably coupled to a pedal 126. The pawl 124 is configured to allow the gear 122 to rotate in the first rotational direction r1 while preventing the gear from rotating in a second rotational direction (same as the second rotational direction r2) opposite to the first rotational direction r1. In some examples, the pawl 124 accomplishes this via engagement between a free end or tip 125 of the pawl 124 and the teeth 128 of the gear 122. The teeth 128 of the gear 122 are angled to allow them to slide under the pawl 124 when rotating in one rotational direction but not to slide under the pawl 124 when rotating in an opposite rotational direction. For example, each one of the teeth 128 includes a curved surface and a substantially straight surface that are angled to mate with the tip 125 of the pawl 124 in a manner that, when the pawl 124 is engaged with the gear 122, only permits movement in one rotational direction. As shown in FIG. 2E, the tip 125 of the pawl 124 rests within a space 129 between the teeth 128 when the gear 122 is not moving.

In some examples, the pawl 124 is configured to prevent the gear 122 from rotating in a given rotational direction by mating with the gear 122, in the spaces 129 between adjacent teeth, such as between a first tooth and a second tooth of the teeth 128. The pawl 124 is permitted to move from that space to a second, adjacent space between the second tooth and an adjacent third tooth in response to rotation of the gear 122 in the permitted rotational direction (e.g., rotational direction r1). However, once the pawl 124 has moved to the second space, the shape of the teeth 128 prevents the pawl 124 from moving back to the first space while the pawl 124 is engaged with the gear 122. In this manner, when a wheel 132 of a bike 130 is pushed against the second tray 116, to rotate the second tray 116 in the first rotational direction r1, the engagement between the teeth 128 and the pawl 124 enable the wheel 132 to be retained in pressed engagement between the first tray 112 and the second tray 116. In such examples, the gear 122 and the pawl 124 help to prevent movement of the wheel 132 in the direction a2 away from the upright portion 108 and enable movement of the wheel 132 in the direction a3 towards the upright portion 108.

To release the wheel 132 from the bike mount 102 (i.e., remove the wheel 132 from between the first tray 114 and the second tray 116), in some examples, the bike mount 102 includes a pedal 126. The pedal 126 is operably connected to the pawl 124 and is actuated to move the pawl 124 away from the gear 122, which disengages the tip 125 from the teeth 128 and allows the gear 122, and thus the second tray 116, to freely rotate in either rotational direction r1 and r2. Referring to FIG. 2E, the pedal 126 is directly or indirectly coupled to the pawl 124 such that depressing the pedal 126 releases the tip 125 of the pawl 124 from contact with the gear 122. In some examples, the pedal 126 is spring-loaded so that the pedal 126 is biased to keep the pawl 124 engaged with the teeth 128 when the pedal 126 is not depressed. Once the pedal 126 is depressed with enough force to overcome the bias, the pawl 124 releases the gear 122 and the second tray 116 is allowed to freely rotate in the second rotational direction r2, thus releasing the wheel from between the trays. In some examples, the pedal 126 is configured and located to be actuated by a foot of the user while the user has hands on the handlebar of the bike. Accordingly, a user also need not manually contact the bike mount 102 with his/her hands to remove the bike 130 from the bike mount 102.

Referring to FIG. 2F, in some examples, the pedal 126 includes a biasing element 194 (e.g., a ball-nose spring plunger) that is configured to engage an aperture 192 or recess formed in the housing 123 (see, e.g., FIG. 1A) when the pedal 126 is depressed to release the wheel 132 from the bike mount 102. When engaged with the aperture 192, the biasing element 194 prevents the pedal 126 from returning to its unpressed state, and thus prevents the pawl 124 from engaging with the gear 122. The pedal 126 remains in the depressed state until a release force, applied to the pedal 126 by the user (such as the foot of the user) in the first rotational direction r1, overcomes the biasing force of the biasing element 194 and the pedal 126 is allowed to return to its unpressed state and the pawl 124 is allowed to engage the gear 122. In this manner, a user need not keep his foot on the pedal 126 as the wheel 132 is removed from the bike mount 102, but can depress and release the pedal 126 once to keep the pedal 126 in the depressed state while he/she removes the wheel 132. When the user is ready to mount the same or another bike to the bike mount 102, the user can use his/her foot to pull up on the pedal 126 and release the biasing element 194 from the aperture 192.

According to the illustrated examples, the gear 122 and the pawl 124 are positioned on only one side of the second tray 116, and the first tray 112 is not restricted by any ratcheting system. For example, referring to FIG. 2B, the gear 122 and the pawl 124 are located on the same side of the second tray 116 as the pedal 126.

In some examples, the bike mount 102 includes additional means of securing a bike 130 to the bike mount 102. For example, as mentioned, the base portion 110 includes the strap 148, which is configured to extend up from the base portion 110 and fit around a portion of the bike 130, such as a rear wheel 132 of the bike 130. In some examples, the strap 148 includes Velcro, snaps, buttons, rings, bungee cords, zip-ties, or any combination thereof. Referring to FIG. 1B, the strap 148 is shown fitting around a rear wheel 132 of the bike 130 while the front wheel 130 is received between the first tray 112 and the second tray 116.

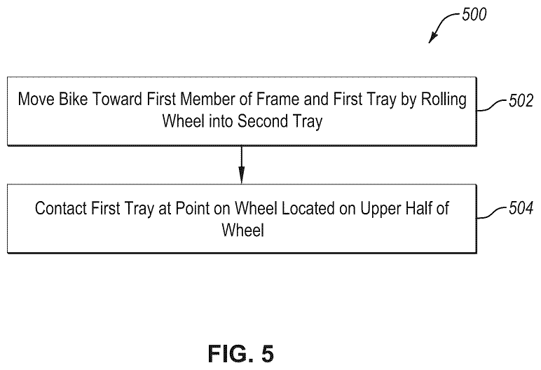

FIGS. 4A-5 illustrate one example of a method 500 of mounting a bike 130 onto a bike mount 102. In some examples, the method is performed without engagement between the user's hands and the bike mount 102. The method 500 of mounting the bike 130 onto the bike mount 102 includes moving (block 502) the bike 130 in a first direction a3 towards the upright portion 108 of the frame 106 and towards the first tray 112. In some examples, the bike 130 is moved in the direction a3 by rolling a wheel 132 of the bike 130 onto the second tray 116. In some examples, the method 500 includes adjusting a distance d1 between the first tray 112 and the second tray 116 to accommodate the diameter of the wheel 132 by adjusting the length L1 of the base portion 110 before moving the wheel 132 onto the second tray 116.

Moving the wheel 132 onto the second tray 116 causes the second tray 116 to pivot in the first rotational direction r1 and can cause the axle 121 coupled to the base portion 110 to rotate in the same rotational direction. Moving the bike 130 in the first direction a3 also causes the gear 122 coupled to the axle 121 to rotate in the first rotational direction r1 with the second tray 116 and the axle 121. Moving the bike 130 at block 502 also causes the pawl 124 to, via contact with the gear 122, prevent the gear and the second tray 116 from moving in the second rotational direction r2 opposite to the first rotational direction r1. The pawl 124 prevents the bike 130 from moving in a second direction a2 opposite to the first direction a3.

The method 500 further includes (block 504) contacting 504 the first tray 108 at a point (e.g., point 134) on the wheel 132 that is located on the upper half of the wheel 132. In some examples, the method 500 includes releasing the pawl from the gear 122 via the pedal 126 to allow the gear 122 and the second tray 116 to rotate in the second rotational direction r2 and to allow the user to move the bike in the second direction a2, thus dismounting the bike 130 from the bike mount 102. In some examples, the method 500 also includes securing a portion of the bike 130 (e.g., a back wheel 132b) to the base portion 110 via the strap 148 of the base portion 110.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A bike mount, comprising:
a frame comprising an upright portion and a base portion, the base portion extending at an angle with respect to the upright portion;
a first tray pivotally coupled to the upright portion, pivotable in a second rotational direction, and comprising a first-tray wheel receptacle;
an axle rotatably coupled to the base portion;
a second tray co-rotatably coupled to the axle and pivotally coupled to the base portion via the axle, wherein the second tray is configured to rotate the axle in a first rotational direction, opposite the second rotational direction, when the second tray is pivoted in the first rotational direction, and the second tray comprises a second-tray wheel receptacle; and
a ratcheting mechanism coupled with the axle and configured to enable pivoting of the second tray, via rotation of the axle, in the first rotational direction and to selectively prevent pivoting of the second tray in the second rotational direction.

2. The bike mount of claim 1, wherein the ratcheting mechanism comprises:
a gear co-rotatably coupled to the second tray via the axle;
a pawl moveable between an engagement position, in which the pawl is engaged with the gear to prevent rotation of the gear in the second rotational direction, and a non-engagement position, in which the pawl is disengaged from the gear to enable rotation of the gear in the second rotational direction; and
a foot pedal operably coupled to the pawl to move the pawl between the engagement position and the non-engagement position as the foot pedal is actuated.

3. The bike mount of claim 2, wherein:
the foot pedal moves the pawl from the engagement position to the non-engagement position as the foot pedal is depressed; and
the foot pedal moves the pawl from the non-engagement position to the engagement position as the foot pedal is unpressed.

4. The bike mount of claim 1, wherein:
the second tray is configured to pivot in the first rotational direction in response to a wheel rolling onto the second tray and towards the upright portion; and
the first tray is configured to pivot in the second rotational direction, concurrently with the pivoting of the second tray in the first rotational direction, in response to the wheel rolling towards the upright portion onto the second tray and into the first tray.

5. The bike mount of claim 1, wherein a distance, between the first tray and the second tray in a direction away from the upright portion toward the second tray, is adjustable.

6. The bike mount of claim 1, wherein:
the first tray faces away from the upright portion and towards the second tray; and
the second tray faces away from the base portion and towards the first tray.

7. The bike mount of claim 1, wherein:
the first tray comprises a curved receptacle defining a radius of curvature;
the upright portion comprises a pivot point about which the first tray is configured to pivot; and
the pivot point is located a distance above the base portion that is less than two times the radius of curvature and equal to or greater than the radius of curvature.

8. The bike mount of claim 1, wherein:
the base portion further comprises at least one telescoping bar and a wheel strap attached to the at least one telescoping bar; and
the at least one telescoping bar is actuatable to adjust a total length of the base portion without adjusting a distance, between the first tray and the second tray in a direction away from the upright portion toward the second tray.

9. The bike mount of claim 8, wherein:
the at least one telescoping bar is configured to extend a first end of the base portion away from the upright portion in a direction substantially parallel to the base portion; and
the base portion is coupled to the upright portion at a second end that is opposite to the first end.

10. The bike mount of claim 1, wherein the angle defined between the upright portion and the base portion is not less than 80 degrees and not greater than 100 degrees.

11. The bike mount of claim 1, wherein the upright portion is pivotally coupled to the base portion such that the angle defined between the upright portion and the base portion is adjustable.

12. The bike mount of claim 1, wherein each one of the first tray and the second tray is shaped to at least partially nestably receive a portion of a wheel.

13. The bike mount of claim 1, further comprising a first engagement member co-movably fixed to the first tray, wherein the upright portion comprises a second engagement member configured to selectively releasably engage with the first engagement member to selectively releasably retain the first tray in a wheel receiving orientation.

14. A system, comprising:
a rail configured to be attached to a wall of a vehicle; and
a bike mount, comprising:
a frame comprising an upright portion and a base portion, wherein the upright portion comprises a vehicle-attachment assembly configured to be selectively releasably attached to the rail, and wherein the base portion extends at an angle with respect to the upright portion;
a first tray pivotally coupled to the upright portion, pivotable in a second rotational direction, and comprising a first-tray wheel receptacle;
an axle rotatably coupled to the base portion;
a second tray co-rotatably coupled to the axle and pivotally coupled to the base portion via the axle, wherein the second tray is configured to rotate the axle in a first rotational direction, opposite the second rotational direction, when the second tray is pivoted in the first rotational direction, and the second tray comprises a second-tray wheel receptacle; and
a ratcheting mechanism coupled with the axle and configured to enable pivoting of the second tray, via rotation of the axle, in the first rotational direction and to selectively prevent pivoting of the second tray in the second rotational direction.

15. The system of claim 14, wherein:
the rail is an L-track rail comprising a plurality of linearly aligned slots;
the vehicle-attachment assembly comprises at least one protrusion; and
each one of the at least one protrusion is configured to be releasably retained within a corresponding one of the linearly aligned slots of the L-track rail.

16. The system of claim 14, wherein:
the base portion of the bike mount is configured to contact a floor of the vehicle when the vehicle-attachment assembly of the upright portion is attached to the rail; and
the upright portion is configured to extend substantially parallel to the wall of the vehicle when the vehicle-attachment assembly is attached to the rail.

17. A method of mounting a bike to an object, the method comprising:
moving a front wheel of a bike in a first direction into a second tray of a bike mount fixed to the object;
pivoting the second tray in a first rotational direction when the front wheel is in the second tray and the front wheel is moved in the first direction;
after moving the front wheel into the second tray, moving the front wheel of the bike in the first direction into a first tray of the bike mount;
pivoting the first tray in a second rotational direction, opposite the first rotational direction, when the front wheel is in the first tray, the front wheel is moved in the first direction, the front wheel is in the second tray, and the second tray is pivoting in the first rotational direction;
selectively preventing the second tray from pivoting in the second direction to retain the front wheel between the first tray and the second tray; and
selectively enabling the second tray to pivot in the second direction to remove the front wheel from between the first tray and the second tray.

18. The method of claim 17, wherein:
selectively preventing the second tray from pivoting comprises selectively engaging a pawl with a gear that is co-rotatably coupled with the second tray; and
selectively enabling the second tray to pivot in the second direction comprises selectively disengaging the pawl from the gear.

19. The method of claim 18, wherein:
selectively engaging the pawl comprises actuating a foot pedal, operably coupled with the pawl, from a first position to a second position;
selectively disengaging the pawl comprises actuating the foot pedal from the second position to the first position.

20. The method of claim 17, further comprising:
adjusting a distance between the first tray and the second tray;
adjusting a distance between the second tray and a strap of the bike mount; and
securing a rear wheel of the bike to the bike mount via the strap.
